(19) United States
(12) Patent Application Publication
(10) Pub. No.: US 2006/0169081 A1
(43) Pub. Date: Aug. 3, 2006

(54) Actuator

(76) Inventor: Simon Betson, Co. Kildare (IE)

Correspondence Address: DICKSTEIN SHAPIRO MORIN & OSHINSKY LLP, 2101 L Street, NW, Washington, DC, 20037, US

(21) Appl. No.: 10/505,327

(22) PCT Filed: Feb. 21, 2003
(86) PCT No.: PCT/IE03/00027

§ 371 Date: Aug. 31, 2005

(30) Foreign Application Priority Data
Feb. 21, 2002 (IE) S 020132

(51) Int. Cl. F16H 1/16

(52) U.S. Cl. 74/425

(57) ABSTRACT

An actuator comprises a series of elements 414 each pivoted to the next and a housing 400 accommodating at least part of the series of elements with one end of the series projecting freely beyond an exit 404 of the housing. The elements 414 are guided to follow a curved path to the housing exit 404 and are driven along the path by a drive mechanism 412 to vary the total length of elements projecting beyond the exit. The projecting elements are maintained in linear alignment in a substantially rigid, self-supporting column 440 by a toothed belt 426 which progressively engages the elements 414 as they emerge from the housing exit 404.

This invention relates to an actuator.

According to the present invention there is provided an actuator comprising a series of elements each rotatable relative to the next, a housing accommodating at least part of the series of elements with one end of the series projecting freely beyond an exit of the housing, the elements being guided to follow a non-linear path to the exit, means for driving the series of elements relative to the housing to vary the total length of elements projecting beyond the exit, and means for maintaining the projecting elements in linear alignment in a substantially rigid, self-supporting column.

One application of the invention is in the construction of adjustable-height beds. If four such actuators were located at or near the four corners of the bed, with the linearly aligned columns of projecting elements arranged vertically and serving as the legs of the bed, then by driving the four sets of elements in synchronism the bed may be raised or lowered as desired. Alternatively, by driving the actuators only at the head or foot of the bed the latter may be tilted as desired. Also, the ability of the elements to follow a non-linear path means that those elements not forming part of a leg of the bed at any given time can be accommodated horizontally along the frame of the bed or in any other orientation depending on the space available. However, the invention is not limited to that application.

Embodiments of the invention will now be described, by way of example, with reference to the accompanying drawings, in which:

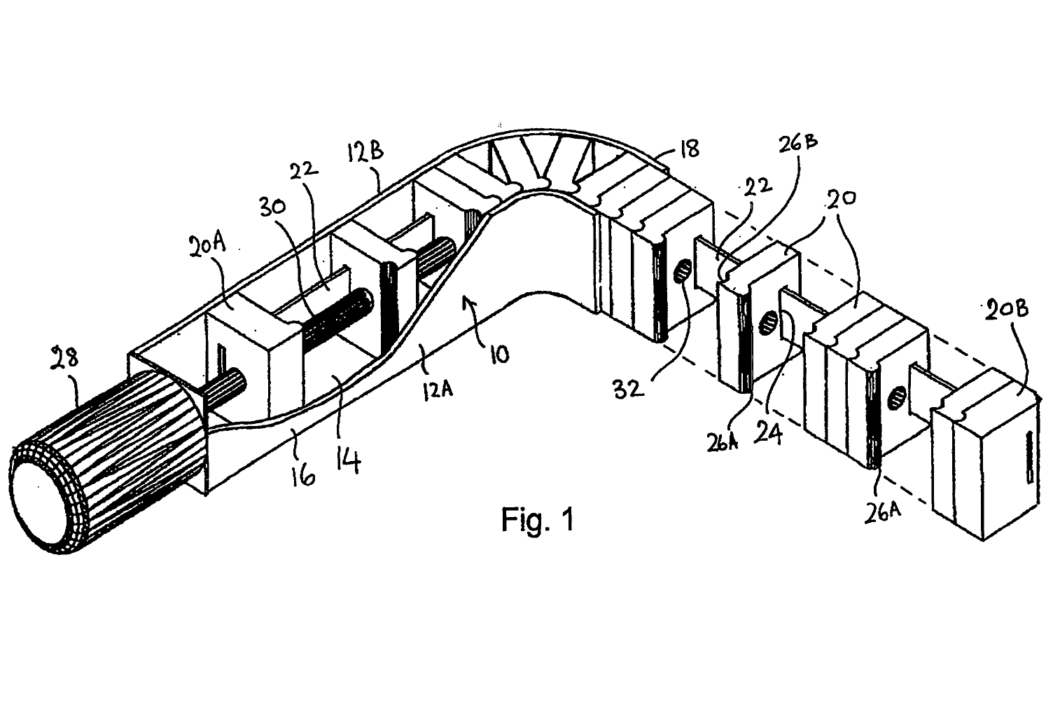

FIG. 1 is a partially cutaway perspective view of a first embodiment of the invention;

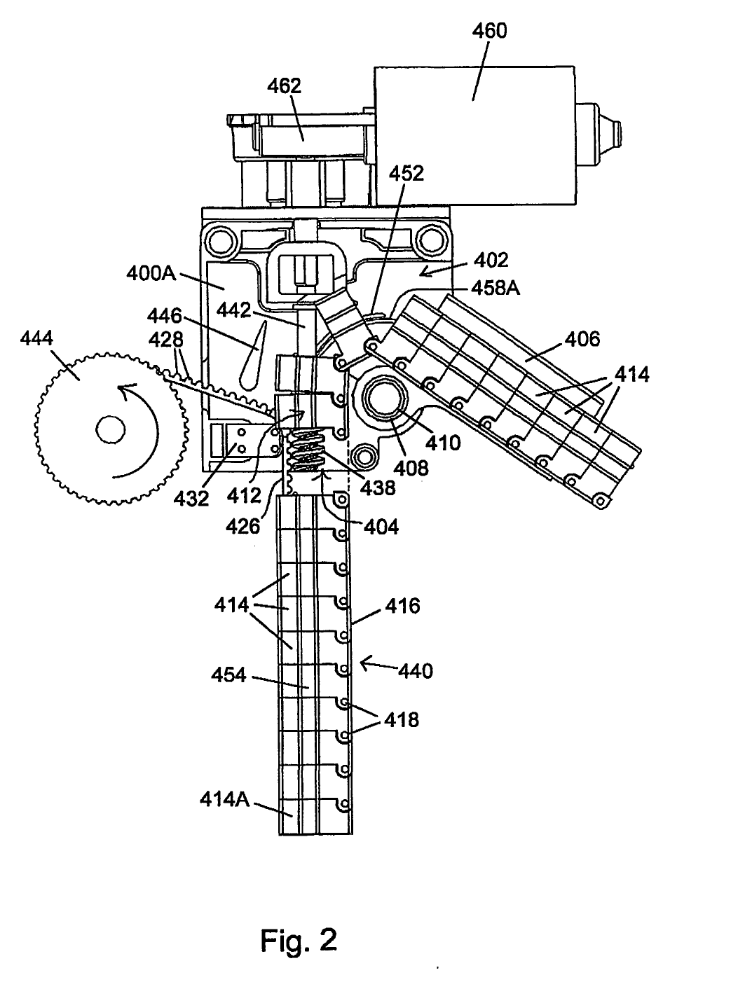

FIG. 2 is a side view of a second embodiment of the invention with certain components removed to reveal the underlying structure;

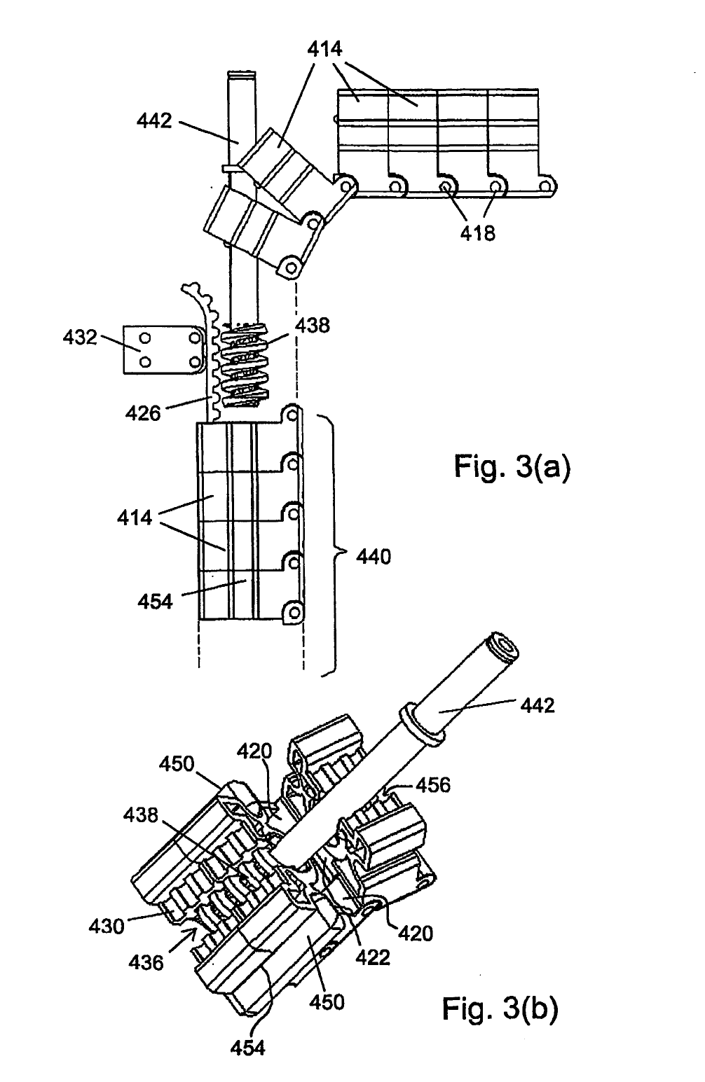

FIG. 3(a) is a diagram showing the principle of operation of the drive mechanism of the second embodiment;

FIG. 3(b) is a perspective view of part of the drive mechanism;

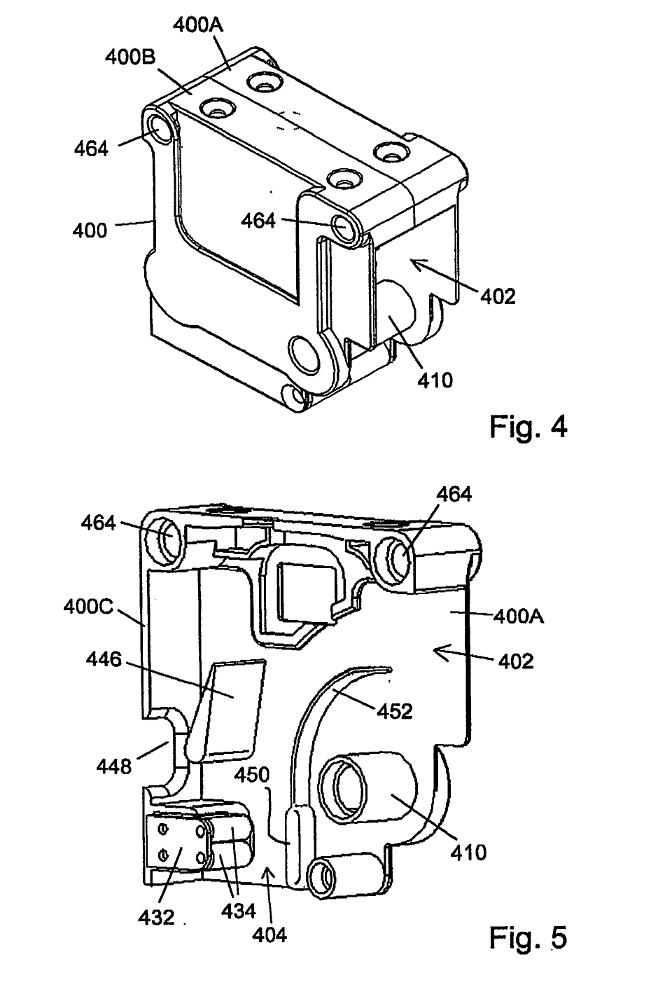

FIG. 4 is an external perspective view of the drive housing of FIG. 2;

FIG. 5 is a perspective view of the inside of one half of the drive housing, the other half being a mirror image of that shown;

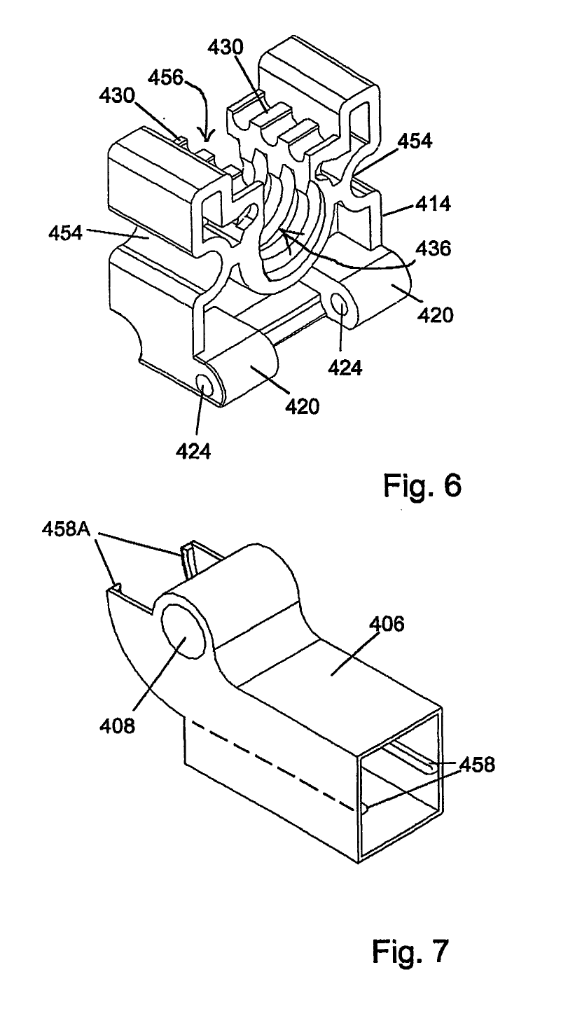

FIG. 6 is a perspective view of one of the linked elements of the embodiment of FIG. 2;

FIG. 7 is a perspective view of the rotatable input guide of the embodiment of FIG. 2; and

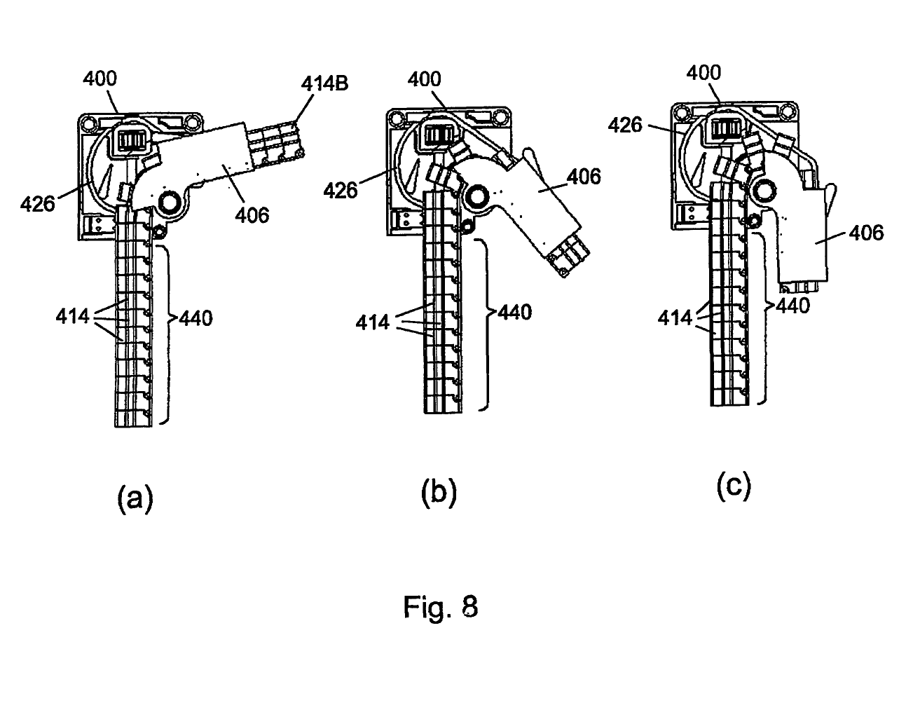

FIGS. 8(a) to 8(c) show the actuator of FIG. 2 with the input guide set at various angles.

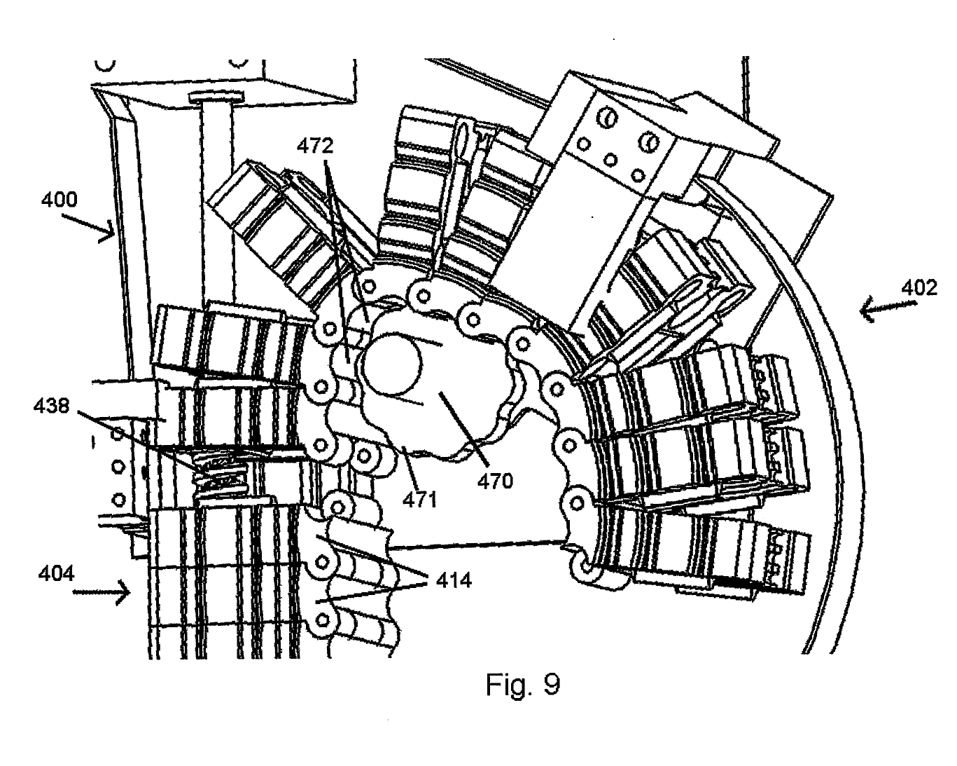

FIG. 9 is a side view of a third embodiment of the invention with certain components removed to reveal the underlying structure;

In the following description the use of expressions of orientation such as top, bottom, vertical, etc., refer to the orientation of the embodiments as seen in drawings and do not constrain their orientation in use.

Referring to FIG. 1, an actuator comprises a rigid guide 10 having a pair of opposite substantially parallel inner and outer sidewalls 12A, 12B respectively (the inner sidewall 12A is shown partially cut away), a bottom wall 14 joining the lower edges of the sidewalls 12A, 12B and a top wall (not shown) joining the upper edges of the sidewalls 12A, 12B. The guide 10 is therefore a tunnel-like housing of substantially constant rectangular cross-section. The guide 10 has a relatively long linear input section 16 and a much shorter exit section 18, and curves through 90° between them.

A series of similar rigid elements, in the form of generally rectangular steel blocks 20, are held in tight registering engagement by a tensioned flexible steel strip 22 which is fixed at one end to the end block 20A and at the other end to the opposite end block 20B. Between these two end blocks 20A, 20B the strip 22 passes freely through aligned vertical slots 24 in the intermediate blocks 20. It will be understood that certain of the blocks 20 are omitted from FIG. 1 in order to show the underlying structure more clearly. In reality, except at the bend in the guide 10, the blocks 20 are maintained in tight face-to-face engagement all along the strip 22 by the tension in the strip which imparts a compressive force to the blocks.

As seen, the series of blocks 20, held together by the tensioned strip 22, are accommodated in the guide 10 such that the end block 20A is located within the relatively long linear input section 16 and the end block 20B is outside the guide, beyond the exit section 18. The cross-section of each block 20, taken in a vertical plane normal to the longitudinal direction of the strip 22, is just slightly smaller than the internal dimensions of the guide 10 to allow the blocks to move smoothly to and fro along the guide.

Along its inner edge each block 20 has a forward-facing vertical rib 26A (the forward direction is taken to be the direction towards the end block 20B) and a rearward-facing vertical groove 26B. These have complementary curved surfaces such that the rib 26A of each block 20 engages the groove 26B of the next adjacent block. This allows the blocks to rotate smoothly relative to one another as they pass around the 90° bend in the guide 10, since around the bend the distance along the outer sidewall 12B is longer than the distance along the inner sidewall 12A so that the outer edges of the blocks 20 have to separate at that point, as seen in FIG. 1. Also, the inner edges of the slots 24 can be radiused to lessen the friction between the blocks 20 and the strip 22 around the bend in the guide 10.

It will be evident that if the end block 20A is pushed towards the exit section 18 of the guide 10 there will be a greater number of blocks projecting beyond the output section, whereas if the end block 20A is pulled away from the exit section 18 there will be a lesser number of blocks thus projecting. Thus the total length of the blocks 20 projecting beyond the exit section 18 of the guide 10 is determined by the position of the block 20A in the relatively long linear input section 16.

Adjustment of the position of the block 20A in the input section 16 is effected by a linear actuator comprising an electric motor 28 which rotates a lead screw 30. The motor 28 is mounted on the input end of the guide 10 and the lead screw 30 passes axially along the centre of the input section 16. Each block 20 except the end block 20A has a central hole 32 of sufficient diameter to allow the lead screw to pass freely through it. However, the end block 20A is designed as a nut, so that it is screw-threadedly engaged by the lead screw 30. Thus, depending upon the direction of rotation of the lead screw 30, the end block 20A will either be driven towards or away from the exit section 18 of the guide, thereby varying the total length of the blocks 20 projecting beyond the exit section 18.

Due to the tension in the strip 22 keeping the blocks 20 tightly up against one another and the engaging ribs 26A and grooves 26B on adjacent blocks, the length of the blocks 20 projecting beyond the exit section 18 cannot readily twist or rotate out of face-to-face engagement. They are therefore maintained linearly aligned in a substantially rigid self-supporting column.

A second embodiment of the invention is shown in FIGS. 2 to 8. This embodiment comprises a drive housing 400 (FIGS. 2, 4 and 5) which comprises two opposite halves 400A, 400B of which the inside structure of the housing half 400A is shown in FIG. 5. The housing half 400B is a mirror image of the housing half 400A, and the two halves are secured together along their edges 400C (FIG. 5) to form the complete housing seen in FIG. 4. The drive housing 400 has an entrance 402 on one side and an exit 404 at the bottom. The drive housing 400 may be moulded from aluminium or plastics material, or cast in steel, according to its dimensions and the intended loading.

A hollow, tunnel-like input guide 406 (FIGS. 2 and 7) is mounted at the drive housing entrance 402. In particular, the guide 406 has a transverse cylindrical bore 408 which is engaged by a hollow cylindrical shaft 410 extending between the opposite major walls of the drive housing 400 to allow rotation of the entire guide 406 about the axis of the shaft 410 (FIG. 8). The housing 400 contains a drive means 412 to be described later.

A series of similar rigid hollow elements 414, moulded from plastics material, are connected to one another along one edge 416 of the series of elements for rotation about substantially parallel axes 418. To this end the front of each element 414 has a short pair of arms 420 which embrace a flange 422, FIG. 3(b), on the rear of the preceding element, the arms and flange having aligned holes 424 through which passes a steel pivot pin (not shown). These pivot pins allow each element 414 to rotate relative to the next element such that the elements may assume a linearly aligned configuration wherein each element is in registering engagement with the next across its full width, as seen for the elements at the top right and bottom of FIG. 2, or may separate from its neighbours at its outer edges to allow the elements to change direction through the housing 400 as will be described. It will be understood that certain components are omitted from FIG. 2, for example the housing half 400B and some of the elements 414, in order to show the structure more clearly.

The pivotally connected series of elements 414 are accommodated in the drive housing 400 such that one end of the series is located within the input guide 406 and the other end of the series is outside the housing 400, projecting beyond the exit 404. Between these two ends the series of elements 414 curves through a variable angle dependent on the angular position of the input guide 406.

In order to maintain the elements 414 which project beyond the exit 404 linearly aligned in a substantially rigid self-supporting column 440, a flexible, substantially inelastic toothed belt 426 is provided. This may be made of the same material as is used for timing belts in motor vehicles. The belt 426 is fixed by staking or welding to the end element 414A and its teeth 428 engage corresponding teeth 430—FIGS. 3(b) and 6—recessed into the edges of the elements 414 along the opposite edges of the elements to the pivots 418. The belt 426 is maintained in engagement with the elements 414 throughout the length of the projecting column by a roller assembly 432 mounted in the housing 400 and which comprises two rollers 434 (FIG. 3) which press the belt 426 into proper engagement with the elements 414. The engagement of the belt teeth 428 with the element teeth 430 all along the length of the projecting column of elements prevents these from pivoting relative to one another and maintains them tight up against one another.

Each element 414 has a helically-threaded bore 436 whose axis, when the element is in linear alignment with other such elements in the projecting column 440, is coaxial with the other such bores in the column 440 to form a continuous helical thread along the centre of the column. The drive means 412 comprises a worm gear 438 disposed at the free end of a drive shaft 442 whose rotational axis is coaxial with that of the bores in the column 440. The worm gear 438 meshes with at least one element 414 in the column 440 at any one time such that rotation of the worm gear progressively drives the elements out of the housing 400, or draws them into the housing 400, thereby increasing or decreasing the length of the column 440, according to the direction of rotation of the worm gear.

The belt 426, which passes out of the drive housing 400 through a hole 448 (FIG. 5), is accommodated on a take-up spool 444 which is biased by a coil spring (not shown) for rotation in a direction which maintains the belt 426 under slight tension and tends to wind the belt on the spool, as indicated by the arrow in FIG. 2. As the projecting column 440 increases in length the belt 426 is pressed by the roller assembly 432 progressively into engagement with consecutive elements 414 as they emerge from the housing exit 404, against the bias of the coil spring. When the column 440 is decreasing in length the belt 426 progressively disengages the elements 414 and is wound onto the spool 444 by the coil spring. A fin-like element 446 in the housing 400 ensures that the belt 426 separates cleanly from the elements 414.

Within the housing 400 the elements 414 follow a non-linear path between the entrance 402 to the exit 404.

This path is defined by a first, straight guide rail 450 near the exit 404 which is contiguous with a second, part-circular guide rail 452 whose centre of curvature is coaxial with the shaft 410 (it will be understood that due to the mirror image construction of the housing halves 400A and 400B the guide rails 450, 452 shown in FIG. 5 are duplicated on the inside surface of the opposite housing half so as to form a pair of guide rails in each case). Each element has a groove 454 along each opposite side and these are engaged in the housing 400 by the guide rails 450 and 452 to direct the element along the desired path between the entrance 402 and exit 404. The pair of straight guide rails 450 resists the turning torque produced on the element 414 by the worm gear 438 so as to keep each element 414 straight as the belt 426 engages or disengages.

To allow each element 414 to join or leave the column 440 by rotation relative to the next element as it follows the pair of curved guide rails 452, each element 414 has a side opening 456 for passage of the drive shaft 442, see especially FIG. 3(b). The width of the opening 456 is preferably such as to leave at least 80% of the circumference of the threaded bore 436.

The input guide 406 also has a pair of guide rails 458 extending continuously through the length of the guide. In the main body of the guide 406 the guide rails are straight, as indicated by the dashed line in FIG. 7, but the portions 458A at the front of the guide are part-circular and concentric with the axis of the shaft 410. The radius of the portions 458A is slightly less than that of the guides 452 so that the latter ride over the former as seen in FIG. 2, the degree of overlap depending on the angle of the input guide 406 relative to the drive housing 400. Thus the pairs of guides 450, 452 and 458 form a continuous guide for the elements 414 from the drive housing exit 404 to the rear end of the input guide 406.

In FIG. 2 the shaft 442 is shown being driven by an electric motor 460 via a gearbox 462, but any other suitable arrangement may be used. For example, the shaft 442 may be driven by a belt.

As mentioned previously, the input guide 406 is rotatable relative to the drive housing 400 to permit the angle of the input guide to be varied relative to the column 440. In this embodiment the angle can be varied between about 60 and 180 degrees, as seen in FIG. 8. FIG. 8 also shows a variation of the embodiment shown in FIG. 2 where the toothed belt 426 is not attached to a take-up spool but is instead fed round loosely in the drive housing 400 to re-engage the elements 414 where they emerge from the input guide 406 into the housing. From that point the belt extends along and in engagement with all the elements 414 in the guide 406 and beyond the free end of the guide 406 to the end element 414B, FIG. 8(a), to which the belt is fixed. This ensures that the elements are maintained in linear alignment prior to entering the guide 406.

A third embodiment of the invention is shown in FIG. 9. This embodiment comprises a sprocket wheel 470 with rounded teeth 471 positioned in the housing 400, coaxial with the shaft 410 (not shown). The teeth 471 of the sprocket wheel engage with curved edge sections 472 of the elements 414. The sprocket wheel 470 is thus indirectly driven by the worm gear 438 via the elements 414. The sprocket wheel acts to help reduce the friction between the elements 414 and the guide rails in the housing and and the input guide (not shown), by imparting a guiding force to the elements as they are rotated through the angle between the entrance 402 and the exit 404. The guide rails ensure that contact is maintained between the sprocket wheel and the elements, while the elements are being rotated. With the sprocket wheel, any back pressure on the elements due to friction between the elements and the guide rails is alleviated, and the elements move more freely.

In one embodiment, the elements 414 could follow a helical path within the drive housing 400, up to the point where they emerge from the exit 404.

In a further variation of the embodiment shown in FIG. 2 the belt 426 can be omitted entirely. In that case the elements 414 can be manually secured to one another as they emerge from the housing exit 404. For example, along their edges opposite the edge 416 (FIG. 1) the elements could have cooperating formations, not shown, similar to the arms 420 and flanges 422 shown in FIG. 3(b). Then, as each element 414 emerges from the housing exit 404 and lines up with the preceding element the flange on one element would come to lie between the arms of the other element and a pin could be manually inserted into the aligned holes in these components thus locking them together face-to-face. Similarly, upon withdrawal of the elements into the housing, the pins could be removed one by one. It is also possible to devise a mechanism whereby the pins are inserted and removed automatically.

In use of the actuator the drive housing 400 is fixed to the frame of a bed or other apparatus for which lifting and/or other mechanical action is required. The drive housing 400 can be bolted rigidly and non-rotatably to the frame by bolts passing through holes 464. Alternatively, the drive housing 400 can be rotatably fixed to the frame by a single bolt passing through the hollow shaft 410. This latter fixing arrangement would be desirable, for example, where the column 440 constitutes the leg of a bed and the drive housing is fixed to the side frame of the bed. In such a case, if the head of the bed is lifted or lowered relative to the foot and the side frame becomes sloped, the rotation of the drive housing 400 allows the leg to remain vertical.

Although the term “actuator” has been used in the description to describe the device of the invention, it is to be understood that the term “articulator” could also be applied to the device.

The invention is not limited to the embodiments described herein which may be modified or varied without departing from the scope of the invention.

1. An actuator comprising a series of elements each rotatable relative to the next, a housing accommodating at least part of the series of elements with one end of the series projecting freely beyond an exit of the housing, the elements being guided to follow a non-linear path to the exit, means for driving the series of elements relative to the housing to vary the total length of elements projecting beyond the exit, and means for maintaining the projecting elements in linear alignment in a substantially rigid, column.

2. An actuator as claimed in claim 1, wherein the maintaining means comprises a flexible, substantially inelastic toothed belt which is brought progressively into positive engagement with the elements as they rotate into alignment with the column.

3. An actuator as claimed in claim 2, wherein the elements are pivotally coupled each to the next along one edge of the series of elements and the belt is brought into engagement with the elements along the opposite edge.

4. An actuator as claimed in claim 1, wherein the elements are hollow and the drive means includes at least one gear located inside the elements as they pass through the housing and which drivingly engages an inside surface of the elements, the elements having an opening on one side which allows passage of a support means for the gear wheel.

5. An actuator as claimed in claim 4, wherein each element has a helically-threaded bore whose axis, when the element is in the linearly aligned column, is coaxial with other such bores in the column to form a continuous helical thread along the column, and wherein the gear wheel comprises a worm gear disposed at the free end of a drive shaft whose rotational axis is coaxial with that of the bores in the column, the worm gear meshing with at least one element in the column at any one time such that rotation of the worm gear increases or decreases the length of the column according to the direction of rotation of the worm gear, each element having a side opening for passage of the drive shaft to allow each element to join or leave the column by rotation relative to the next element.

6. An actuator as claimed in claim 2, wherein the series of elements enters the housing through an input guide which is rotatable relative to the housing over a range of angles relative to the linearly aligned column.

7. An actuator as claimed in claim 6, wherein the elements are engaged by the belt in the input guide whereby the elements are maintained in linear alignment prior to entering the guide.

8. An actuator as claimed in claim 1, wherein the actuator further comprises a sprocket wheel which engages with and guides the elements.

9. A device for moving a load comprising a base portion and a load bearing portion and means for moving the load.
